(19) United States
(12) Patent Application Publication
(10) Pub. No.: US 2021/0319445 A1
(43) Pub. Date: Oct. 14, 2021

(54) Method and System for Secure Transfer of Funds among Multiple Parties

(71) Applicant: Capital One Services, LLC, McLean, VA (US)

(72) Inventors: Abdelkader M'Hamed Benkreira, New York, NY (US); Michael Mossoba, Arlington, VA (US); Salik Shah, Washington, DC (US)

(73) Assignee: Capital One Services, LLC, McLean, VA (US)

(21) Appl. No.: 16/843,147

(22) Filed: Apr. 8, 2020

(51) Int. Cl. G06Q 20/40; G06Q 20/08

(52) U.S. Cl. CPC G06Q 20/403; G06Q 20/0855; G06Q 20/405

(57) ABSTRACT

A system and method for securely transferring funds is disclosed herein. A computing system receives a request to transfer funds from a first account associated with the transferor to a second account associated with the transferee. The computing system identifies one or more constraints specified in the request that are associated with the funds. The computing system stores the funds as reserved funds in the second accounts associated with the transferee. The computing system receives, from a third-party vendor, a transaction request for verifying a transaction between the transferee and the third-party vendor. The computing system identifies one or more parameters associated with the transaction request. The computing system determines that the one or more parameters associated with the transaction request are in accordance with the one or more rules related to use of the funds. The computing system grants the transaction request based on the determining.

### FIELD OF THE DISCLOSURE

The present disclosure generally relates to a system and method for securely transferring funds between a transferor and a transferee.

### BACKGROUND

Currently, the act of transferring funds from a transferor account to a transferee account provides the transferee with free reign to transact using the transferred funds. Such operations do not conventionally allow the transferor to control the downstream use of the funds by a transferee. For example, one may imagine a scenario in which a parent transfers funds to a child's account, with the direct intention of the child using the funds for school supplies or text books. Without requesting receipts or other proof of purchase, the parent is typically left without an avenue for ensuring that their child uses those funds for their intended purpose. Although items such as gift card or gift certificates may be used, such alternatives do not provide a simplified mechanism in which a transferor may be able to transfer funds to the transferee with constraints imposed thereon.

### SUMMARY

In one embodiment, a method of securely transferring funds between a transferor and a transferee is disclosed herein. A computing system receives a request to transfer funds from a first account associated with the transferor to a second account associated with the transferee. The computing system identifies one or more constraints specified in the request that are associated with the funds. The one or more constraints define one or more rules related to use of the funds by the transferee. The computing system stores the funds as reserved funds in the second accounts associated with the transferee. The computing system receives, from a third-party vendor, a transaction request for verifying a transaction between the transferee and the third-party vendor. The computing system identifies one or more parameters associated with the transaction request. The computing system determines that the one or more parameters associated with the transaction request are in accordance with the one or more rules related to use of the funds. The computing system grants the transaction request based on the determining.

In some embodiments, the computing system further receives, from a second third-party vendor, a second transaction request for verifying a second transaction between the transferee and the second third-party vendor. The computing system identifies one or more second parameters associated with the second transaction request. The computing system determines that the one or more second parameters associated with the transaction request violate the one or more rules related to use of the funds. The computing system identifies that the transferee has enough funds in the second account, absent the reserved funds, to satisfy the second transaction request. The computing system grants the second transaction request based on the identifying.

In some embodiments, the computing system further receives, from a second third-party vendor, a second transaction request for verifying a second transaction between the transferee and the second third-party vendor. The computing system identifies one or more second parameters associated with the second transaction request. The computing system determines that the one or more second parameters associated with the transaction request violate the one or more rules related to use of the funds. The computing system identifies that the transferee has insufficient funds in the second account, absent the reserved funds, to satisfy the second transaction request. The computing system rejects the second transaction request based on the identifying.

In some embodiments, identifying the one or more parameters associated with the transaction request includes the computing system identifying a merchant category code associated with the third-party merchant.

In some embodiments, receiving, from the third-party vendor, the transaction request for verifying the transaction between the transferee and the third-party vendor includes the computing system receiving a cash withdrawal request from the third-party vendor.

In some embodiments, the computing system further receives, from a second third-party vendor, a second transaction request for verifying a second transaction between the transferee and the second third-party vendor. The computing system identifies one or more second parameters associated with the second transaction request. The computing system determines that the one or more second parameters associated with the transaction request violate the one or more rules related to use of the funds. The computing system identifies that the transferee has insufficient funds in the second account, absent the reserved funds, to satisfy the second transaction request. The computing system determines that the one or more rules comprise an exception for overdraft. The computing system grants, based on the identifying, the second transaction request by first withdrawing a first amount from non-reserved funds and then withdrawing a remaining amount from the reserved funds.

In some embodiments, the computing system receives, from the third-party merchant, a refund in response to a user returning one or more items exchanged in the transaction request. The computing system identifies that the transaction request comprised the reserved funds. The computing system allocates funds associated with the refund to the reserved funds.

In another embodiment, a system is disclosed herein. The system includes a processor and a memory. The memory has programming instructions stored thereon, which, when executed by the processor, performs one or more operations. The one or more operations include receiving a request to transfer funds from a first account associated with a transferor to a second account associated with a transferee. The one or more operations include identifying one or more constraints specified in the request that are associated with the funds. The one or more constraints define one or more rules related to use of the funds by the transferee. The one or more operations include receiving, from a third-party vendor, a transaction request for verifying a transaction between the transferee and the third-party vendor. The one or more operations include identifying one or more parameters associated with the transaction request. The one or more operations include determining that the one or more parameters associated with the transaction request is in accordance with the one or more rules related to use of the funds. The one or more operations include granting the transaction request based on the determining.

In some embodiments, the one or more operations further include receiving, from a second third-party vendor, a second transaction request for verifying a second transaction between the transferee and the second third-party vendor. The one or more operations further include identifying one or more second parameters associated with the second transaction request. The one or more operations further include determining that the one or more second parameters associated with the transaction request violate the one or more rules related to use of the funds. The one or more operations further include identifying that the transferee has enough unreserved funds in the second account to satisfy the second transaction request. The one or more operations further include granting the second transaction request based on the identifying.

In some embodiments, the one or more operations further include receiving, from a second third-party vendor, a second transaction request for verifying a second transaction between the transferee and the second third-party vendor. The one or more operations further include identifying one or more second parameters associated with the second transaction request. The one or more operations further include determining that the one or more second parameters associated with the transaction request violate the one or more rules related to use of the funds. The one or more operations further include identifying that the transferee has insufficient unreserved funds in the second account, absent the reserved funds, to satisfy the second transaction request. The one or more operations further include rejecting the second transaction request based on the identifying.

In some embodiments, identifying the one or more parameters associated with the transaction request includes identifying a merchant category code associated with the third-party merchant.

In some embodiments, receiving, from the third-party vendor, the transaction request for verifying the transaction between the transferee and the third-party vendor includes receiving a cash withdrawal request from the third-party vendor.

In some embodiments, the one or more operations further include receiving, from a second third-party vendor, a second transaction request for verifying a second transaction between the transferee and the second third-party vendor. The one or more operations further include identifying one or more second parameters associated with the second transaction request. The one or more operations further include determining that the one or more second parameters associated with the transaction request violate the one or more rules related to use of the funds. The one or more operations further include identifying that the transferee has insufficient unreserved funds in the second account to satisfy the second transaction request. The one or more operations further include determining that the one or more rules comprise an exception for overdraft. The one or more operations further include, based on the identifying, granting the second transaction request by first withdrawing a first amount from unreserved funds and then withdrawing a remaining amount from reserved funds.

In some embodiments, the one or more operations further include receiving, from the third-party merchant, a refund in response to a user returning one or more items exchanged in the transaction request. The one or more operations further include identifying that the transaction request comprised the reserved funds. The one or more operations further include allocating funds associated with the refund to reserved funds.

In another embodiment, a non-transitory computer readable medium is disclosed herein. The non-transitory computer readable medium includes one or more sequences of instructions that, when executed by one or more processors cause the one or more processors to perform one or more operations. A computing system receives, via a graphical user interface (GUI), a request to transfer funds from a first account associated with a transferor to a second account associated with a transferee. The request includes one or more constraints defined by the transferor via the GUI. The computing system identifies the one or more constraints specified in the request that are associated with the funds. The one or more constraints define one or more rules related to use of the funds by the transferee. The computing system stores the funds as reserved funds in the second accounts associated with the transferee. The computing system receives, from a third-party vendor, a transaction request for verifying a transaction between the transferee and the third-party vendor. The computing system identifies one or more parameters associated with the transaction request. The computing system determines that the one or more parameters associated with the transaction request are in accordance with the one or more rules related to use of the funds. The computing system grants the transaction request based on the determining.

In some embodiments, the computing system further receives, from a second third-party vendor, a second transaction request for verifying a second transaction between the transferee and the second third-party vendor. The computing system identifies one or more second parameters associated with the second transaction request. The computing system determines that the one or more second parameters associated with the transaction request violate the one or more rules related to use of the funds. The computing system identifies that the transferee has enough funds in the second account, absent the reserved funds, to satisfy the second transaction request. The computing system grants the second transaction request, based on the identifying.

In some embodiments, the computing system receives, from a second third-party vendor, a second transaction request for verifying a second transaction between the transferee and the second third-party vendor. The computing system identifies one or more second parameters associated with the second transaction request. The computing system determines that the one or more second parameters associated with the transaction request violate the one or more rules related to use of the funds. The computing system identifies that the transferee has insufficient funds in the second account, absent the reserved funds, to satisfy the second transaction request. The computing system rejects the second transaction request, based on the identifying.

In some embodiments, identifying, by the computing system, the one or more parameters associated with the transaction request includes identifying a merchant category code associated with the third-party merchant.

In some embodiments, receiving, by the computing system from the third-party vendor, the transaction request for verifying the transaction between the transferee and the third-party vendor includes receiving a cash withdrawal request from the third-party vendor.

In some embodiments, the computing system further receives, from a second third-party vendor, a second transaction request for verifying a second transaction between the transferee and the second third-party vendor. The computing system identifies one or more second parameters associated with the second transaction request. The computing system determines that the one or more second parameters associated with the transaction request violate the one or more rules related to use of the funds. The computing system identifies that the transferee has insufficient funds in the second account, absent the reserved funds, to satisfy the second transaction request. The computing system determines that the one or more rules comprise an exception for overdraft. The computing system grants the second transaction request by first withdrawing a first amount from non-reserved funds and then withdrawing a remaining amount from the reserved funds, based on the identifying.

### BRIEF DESCRIPTION OF THE DRAWINGS

So that the manner in which the above recited features of the present disclosure can be understood in detail, a more particular description of the disclosure, briefly summarized above, may be had by reference to embodiments, some of which are illustrated in the appended drawings. It is to be noted, however, that the appended drawings illustrated only typical embodiments of this disclosure and are therefore not to be considered limiting of its scope, for the disclosure may admit to other equally effective embodiments.

FIG. 1 is a block diagram illustrating a computing environment, according to example embodiments.

FIG. 2 is a flow diagram illustrating a method of performing a transaction with reserved funds, according to example embodiments.

FIG. 3 is a flow diagram illustrating a method of performing a transaction with reserved funds, according to example embodiments.

FIG. 4 is a flow diagram illustrating a method of transacting using reserved funds, according to example embodiments.

FIG. 5 is a block diagram illustrating an exemplary graphical user interface (GUI), according to example embodiments.

FIG. 6 is a block diagram illustrating a computing environment, according to example embodiments.

To facilitate understanding, identical reference numerals have been used, where possible, to designate identical elements that are common to the figures. It is contemplated that elements disclosed in one embodiment may be beneficially utilized on other embodiments without specific recitation.

### DETAILED DESCRIPTION

One or more techniques disclosed herein generally relate to a system and method of transferring funds among multiple parties. For example, the one or more techniques described herein allow a transferor of funds to place one or more constraints on the funds transferred from the transferor account to the transferee account. In other words, the transferor may be able to control the downstream use of transferred funds by the transferee. For example, the transferor may set one or more rules on use of the funds, such as, but not limited to, a merchant name, a merchant category code, a type of transaction (cash withdrawal vs. purchase), a date of transaction, an amount of transaction, and the like.

In some embodiments, a transferor may place more nuanced constraints (or rules) on the funds transferred from transferor account to transferee account. For example, the transferor may allow the user to access reserved funds if, for example, the transferee attempts to overdraw from unreserved funds in the transferee's account. Still further, in some embodiments, the transferor may be allowed to withdraw constraints placed upon the transferred funds. For example, if there is a remaining reserved balanced because, for example, the transferor overestimated the amount of funds needed by the transferee for a purchase, rather than forcing the transferee to hold a reserved balance, the transferor may request that those reserved funds be released from their constraints. As such, the one or more techniques described herein allow users to control downstream use of funds in ways that simply were not achievable by conventional processes.

The term “user” as used herein includes, for example, a person or entity that owns a computing device or wireless device; a person or entity that operates or utilizes a computing device; or a person or entity that is otherwise associated with a computing device or wireless device. It is contemplated that the term “user” is not intended to be limiting and may include various examples beyond those described.

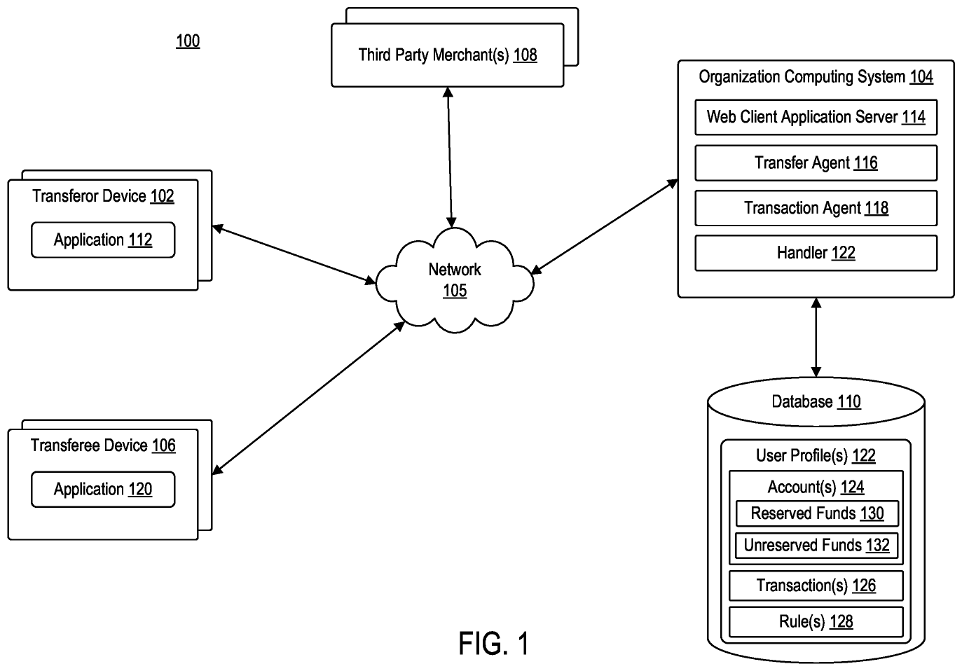

FIG. 1 is a block diagram illustrating a computing environment 100, according to one embodiment. Computing environment 100 may include at least a transferor device 102, an organization computing system 104, a transferee device 106, one or more third-party merchants 108, and a database 110 communicating via network 105.

Network 105 may be of any suitable type, including individual connections via the Internet, such as cellular or Wi-Fi networks. In some embodiments, network 105 may connect terminals, services, and mobile devices using direct connections, such as radio frequency identification (RFID), near-field communication (NFC), Bluetooth™, low-energy Bluetooth™ (BLE), Wi-Fi™ ZigBee™, ambient backscatter communication (ABC) protocols, USB, WAN, or LAN. Because the information transmitted may be personal or confidential, security concerns may dictate one or more of these types of connection be encrypted or otherwise secured. In some embodiments, however, the information being transmitted may be less personal, and therefore, the network connections may be selected for convenience over security.

Network 105 may include any type of computer networking arrangement used to exchange data or information. For example, network 105 may be the Internet, a private data network, virtual private network using a public network and/or other suitable connection(s) that enables components in computing environment 100 to send and receiving information between the components of system 100.

Transferor device 102 may be operated by a user. For example, transferor device 102 may be a mobile device, a tablet, a desktop computer, or any computing system having the capabilities described herein. Transferor device 102 may belong to or be provided to a user or may be borrowed, rented, or shared. Users may include, but are not limited to, individuals such as, for example, subscribers, clients, prospective clients, or customers of an entity associated with organization computing system 104, such as individuals who have obtained, will obtain, or may obtain a product, service, or consultation from an entity associated with organization computing system 104.

Transferor device 102 may include at least application 112. Application 112 may be representative of a web browser that allows access to a website or a stand-alone application. Transferor device 102 may access application 112 to access functionality of organization computing system 104. Transferor device 102 may communicate over network 105 to request a webpage, for example, from web client application server 114 of organization computing system 104. For example, transferor device 102 may be configured to execute application 112 to access content managed by web client application server 114. The content that is displayed to transferor device 102 may be transmitted from web client application server 114 to transferor device 102, and subsequently processed by application 112 for display through a graphical user interface (GUI) of transferor device 102.

Transferee device 106 may be operated by a user. For example, transferee device 106 may be a mobile device, a tablet, a desktop computer, or any computing system having the capabilities described herein. Transferee device 106 may belong to or be provided to a user or may be borrowed, rented, or shared. Users may include, but are not limited to, individuals such as, for example, subscribers, clients, prospective clients, or customers of an entity associated with organization computing system 104, such as individuals who have obtained, will obtain, or may obtain a product, service, or consultation from an entity associated with organization computing system 104.

Transferee device 106 may include at least application 120. Application 120 may be representative of a web browser that allows access to a website or a stand-alone application. Transferee device 106 may access application 120 to access functionality of organization computing system 104. Transferee device 106 may communicate over network 105 to request a webpage, for example, from web client application server 114 of organization computing system 104. For example, transferee device 106 may be configured to execute application 120 to access content managed by web client application server 114. The content that is displayed to transferee device 106 may be transmitted from web client application server 114 to transferee device 106, and subsequently processed by application 120 for display through a graphical user interface (GUI) of transferee device 106.

Organization computing system 104 may include at least web client application server 114, a transfer agent 116, a transaction agent 118, and a handler 122. Each of transfer agent 116, transaction agent 118, and handler 122 may be comprised of one or more software modules. The one or more software modules may be collections of code or instructions stored on a media (e.g., memory of organization computing system 104) that represent a series of machine instructions (e.g., program code) that implements one or more algorithmic steps. Such machine instructions may be the actual computer code the processor of organization computing system 104 interprets to implement the instructions or, alternatively, may be a higher level of coding of the instructions that is interpreted to obtain the actual computer code. The one or more software modules may also include one or more hardware components. One or more aspects of an example algorithm may be performed by the hardware components (e.g., circuitry) itself, rather as a result of an instructions.

Transfer agent 116 may be configured to manage one or more transfers between a transferor and a transferee. For example, transfer agent 116 may be configured to manage a transfer from an account associated with transferor device 102 to an account associated with transferee account 106. Via transfer agent 116, transferor device 102 may place one or more constraints on a transfer between transferor device 102 and transferee device 106. For example, via transfer agent 116, transferor device 102 may place one or more constraints on funds transferred from transferor device 102 to transferee device 106, such that the one or more constraints define one or more rules related to use of the funds by the transferee. Exemplary constraints that transferor device 102 may place on such transfer may include, but are not limited to, one or more merchant names, one or more merchant category codes, a number of transactions using the funds, cash withdrawal, and the like. Transfer agent 116 may store the funds transferred by transferor device 102 to transferee device 106 as reserved funds in the transferee's account. In other words, transfer agent 116 may mark the funds as reserved, such that the user may not use the funds in a way that violates the one or more rules.

In some embodiments, transfer agent 116 may place one or more constraints on an account associated with transferee device 106, in response to the transfer. For example, transfer agent 116 may allocate a certain portion of transferee's funds to a reserved account. As such, a given user may have an unreserved portion of an account and a reserved portion of the account. The unreserved portion may be used for any transaction; the reserved portion may only be used for certain transactions, as defined by one or more transferor's. In some embodiments, whether the user has a minimum balance in his or her account may correspond to whether the user has a minimum balance in the unreserved portion of his or her account. Still further, in some embodiments, whether the user has sufficient funds in his or her account to cover a transactions that would otherwise be accounted for with funds from the unreserved portion of the user account, would be determined by looking at the unreserved portion, while not taking into consideration funds in the reserved portion of his or her account.

Still further, in some embodiments, a transferor may place one or more exceptions on the one or more constraints on the funds associated with the transfer. For example, if a transferee attempts to buy an item that is in excess of the funds in the transferee's unreserved portion of his or her account, but has sufficient funds with a combination of the transferee's unreserved portion and reserved portion, a transferor may allow the transferee to pull funds from the reserved portion as an exception to the one or more constraints.

In some embodiments, a transferor may be able to withdraw any constraints placed one funds transferred to transferee. For example, assume there is a scenario in which the transferee uses reserved funds in accordance with the one or constraints placed by the transferor. However, the transferor overestimated the amount the transaction would cost. Rather than having the transferee carry a balance of the excess reserved funds, transferee may withdraw one or more constraints placed on the funds via application 112.

Transaction agent 118 may be configured to manage one or more transactions of one or more users. For example, transaction agent 118 may be configured to manage one or more transactions for one or more users associated with organization computing system 104. Transaction agent 118 may communicate with one or more third-party merchants 108. For example, a third-party merchant 108 may submit a transaction request to organization computing system 104. Transaction request may include, for example, a merchant name, a merchant category code, the price of an item to be transacted and an account number (e.g., checking account number, credit card account number, etc.) associated with a counterparty to the transaction. Upon receiving a transaction request, transaction agent 118 may query database 110 to determine if the counterparty to the transaction has sufficient funds to perfect the transaction request. In some embodiments, transaction agent 118 may be configured to determine whether the transaction request is associated with one or more constraints. For example, transaction agent 118 may determine that the user has reserved funds in his or her account. Accordingly, transaction agent 118 may determine whether the transaction request satisfies any of the rules associated with reserved funds. For example, transaction agent 118 may analyze one or more of a merchant name, transaction type, merchant category code, monetary amount, date, etc. associated with the transaction request to determine whether the transaction request satisfies any of the one or more rules.

Handler 122 may be configured to manage an account associated with each user. For example, account handler 116 may be configured to communicate with database 110. As illustrated, database 110 may include one or more user profiles 122. Each user profile 122 may correspond to a user with an account with organization computing system 104. Each user profile 122 may include one or more accounts 124, one or more transactions 126, and one or more rules 128.

Each of one or more accounts 124 may correspond to an account with organization computing system 104. Such accounts may include, but are not limited to, checking accounts, savings accounts, credit card accounts, and the like. Each account 124 may include reserved funds 130 and unreserved funds 132. Reserved funds 130 may correspond to funds for which a transferor has placed one or more constraints. For example, reserved funds 130 may correspond to funds transferred to the user, which have one or more constraints as to which transactions reserved funds 130 may be used. Unreserved funds 132 may correspond to one or more funds for which there are no constraints. A user may be free to use unreserved funds 132 for any transaction.

Transactions 126 may correspond to one or more transactions associated with a user account 122. One or more rules 128 may correspond to one or more rules that control disbursement or use of reserved funds 130. Such rules may control the merchant, the type of merchant, the transaction type, transaction amount, and the like.

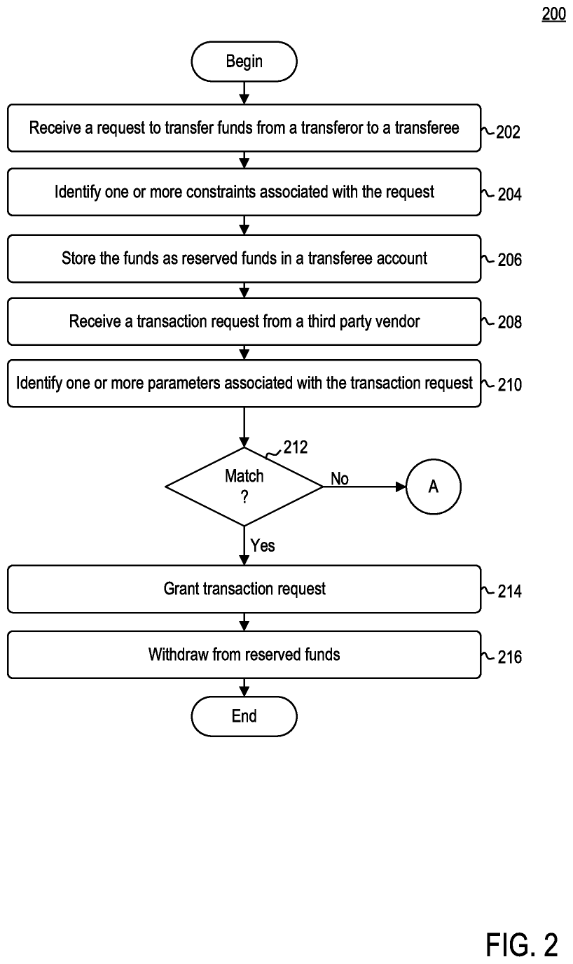

FIG. 2 is a flow diagram illustrating a method 200 of performing a transaction with reserved funds, according to example embodiments. Method 200 may begin at step 202.

At step 202, organization computing system 104 may receive a request to transfer funds from a transferor device 102 to a transferee device 106. For example, organization computing system 104 may receive a request from transferor device 102, via application 112, to transfer funds from an account associated with transferor device 102 to an account associated with transferee device 106. In some embodiments, the transfer request may include one or more constraints associated therewith. The one or more constraints may define one or more rules related to use of the funds by the transferee. For example, the one or more constraints may include, but are not limited to constraints on the specific merchant (e.g., merchant name), merchant type (e.g., merchant category code), amount of the transaction, date of transaction, and the like. In some embodiments, transferor device 102 may define one or more constraints on the transfer, via a GUI displayed thereon.

At step 204, organization computing system 104 may identify one or more constraints associated with the transfer account. For example, transfer agent 116 may parse the transfer request received from transferor device 102 to identify one or more constraints defined by the transferor. In some embodiments, transfer agent 116 may define one or more rules based on the identified constraints. Such rules may be used by organization computing system 104, when organization computing system 104 receives a transaction request associated with transferee's account.

At step 206, organization computing system 104 may store the funds received in the transaction request as reserved funds in the transferee account. For example, transfer agent 116 may partition transferee's account into two portions: an unreserved portion and a reserved portion. Transfer agent 116 may allocate the one or more funds associated with the transfer request in the reserved portion of the transferee's account.

At step 208, organization computing system 104 may receive a transaction request from a third-party merchant 108. For example, transaction agent 118 may receive a transaction request from a third-party merchant 108, when a user attempts to transact with third-party merchant 108. In some embodiments, the transaction request may include one or more parameters contained therein. For example, the one or more parameters may include, but are not limited to, a merchant name, a merchant category code, an account corresponding to the counterparty, a date of the transaction, and the like.

At step 210, organization computing system 104 may identify one or more parameters associated with the transaction request. For example, transaction agent 118 may identify at least one or more of a merchant name, a merchant category code, an account corresponding to the counterparty, a date of the transaction, and the like, associated with the transaction.

At step 212, organization computing system 104 may compare the one or more identified parameters to one or more rules 128 stored in database 110. For example, transaction agent 118 may compare each of the one or more parameters identified in the transaction request to the one or more rules 128 stored in database 110. Transaction agent 118 may determine whether any of the one or more parameters identified in the transaction request satisfies any of the one or more rules 128 stored in database 110.

If, at step 212, organization computing system 104 determines that there is not a match between one or more of the identified parameters and one or more rules 128, then method 200 proceeds to step A.

If, however, at step 212, organization computing system 104 determines that there is a match between one or more identified parameters and at least one rule 128, then method 200 proceeds to step 214. At step 214, transaction agent 118 may grant the transaction request. For example, transaction agent 118 may determine that the user has enough funds in reserved funds 130, and notifies third-party merchant 108 that the request has been approved.

At step 216, organization computing system 104 may withdraw the funds from user's account. For example, transaction agent 118 may withdraw funds from reserved funds 130.

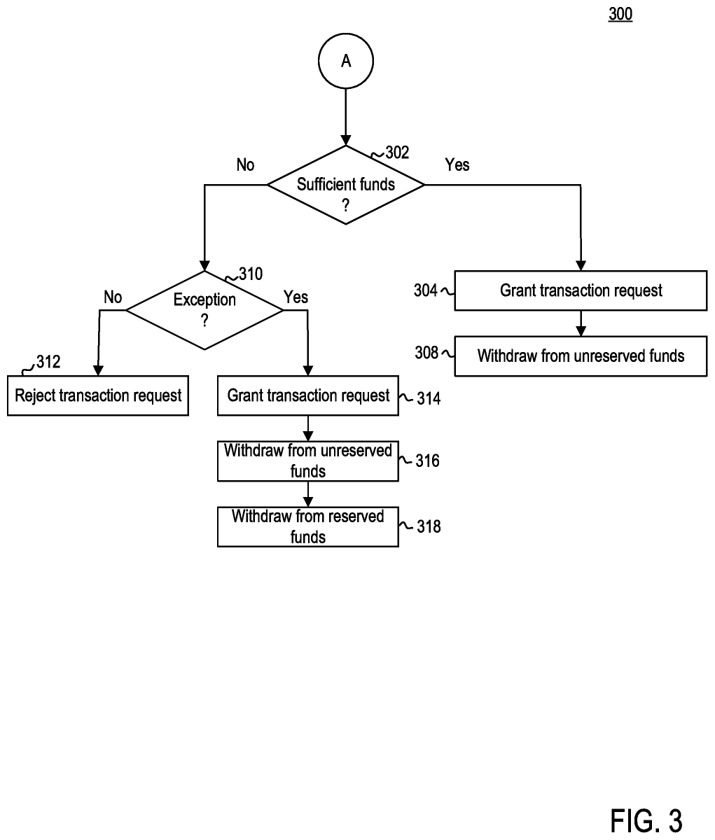

FIG. 3 is a flow diagram illustrating a method 300 of performing a transaction with reserved funds, according to example embodiments. For example, method 300 may represent one or more operations associated with step A from method 200. Method 300 may begin at step 302.

At step 302, organization computing system 104 may determine whether the user has sufficient unreserved funds. For example, transaction agent 118 may determine whether the user has sufficient unreserved funds 132 to clear the transaction request.

If at step 302, organization computing system 104 determine that there are sufficient unreserved funds 132 to clear the transaction request, then method 300 proceeds to step 304. At step 304, organization computing system 104 may grant the transaction request. For example, organization computing system 104 may notify third-party merchant 108 that the transaction was granted. At step 308, organization computing system 104 may withdraw funds from unreserved funds 132 to satisfy the transaction request.

If, however, at step 302, organization computing system 104 determines that there are not sufficient funds in unreserved funds 132 to satisfy the transaction request, then method 300 proceeds to step 310. At step 310, organization computing system 104 may determine if an exception exists. For example, transaction agent 118 may parse rules 128 to determine if an exception to a transaction constraint on reserved funds 130 exists. An exception to a transaction constraint on reserved funds 130 may allow a user to access reserved funds 130 if, for example, a user does not have sufficient unreserved funds 132 to complete a transaction.

If, at step 310, organization computing system 104 determines that an exception does not exist (i.e., a user is unable to access reserved funds 130 for any transaction that does not meet at least one rule 128), then method 300 proceeds to step 312. At step 312, organization computing system 104 may reject the transaction request.

If, however, at step 310, organization computing system 104 determines that an exception does exist, then method 300 may proceed to step 314. At step 314, organization computing system 104 may grant the transaction request. For example, transaction agent 118 may determine that the user has enough funds in unreserved funds 132 to cover the difference between the amount available in reserved funds 130 and the amount in the transaction request, and notifies third-party merchant 108 that the request has been approved.

At step 316, organization computing system 104 may withdraw the funds from user's account. For example, transaction agent 118 may withdraw funds from unreserved funds 132. Once unreserved funds 316 are depleted, at step 318 organization computing system 104 may withdraw funds from reserved funds 130

Although the above operations discuss rules 128 as pertaining to all of reserved funds 130, those skilled in the art may readily understand that reserved funds 130 may be partitioned. For example, reserved funds 130 may include certain funds associated with a first set of rules, certain funds associated with a second set of rules, etc. Accordingly, an exception may only be applicable to certain funds associated with the first set of rules, but not the remaining reserved funds 130.

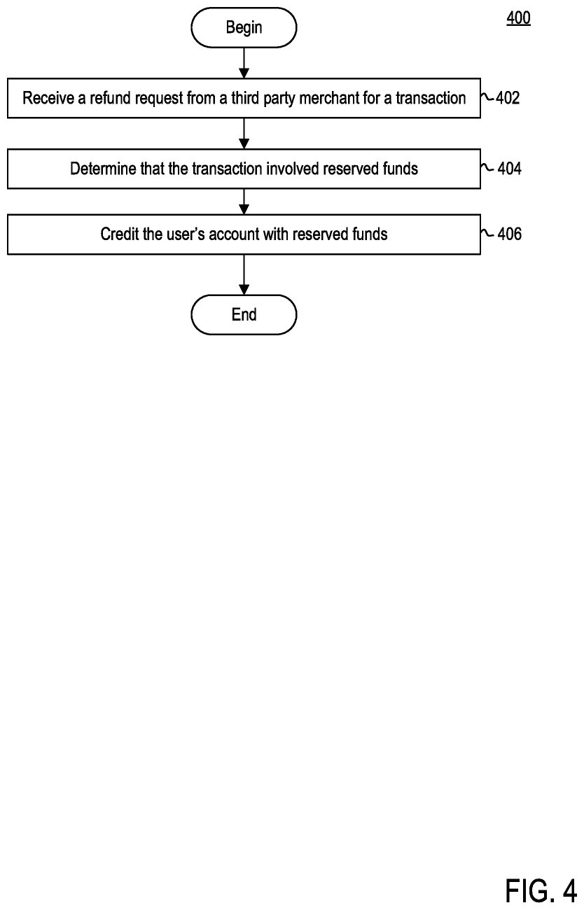

FIG. 4 is a flow diagram illustrating a method 400 of managing a user's account, according to example embodiments. Method 400 may begin at step 402.

At step 402, organization computing system 104 may receive a refund request from a third-party merchant 108 for a transaction. For example, organization computing system 104 may receive a notification from third-party merchant 108 that it is refunding a user the purchase amount in a transaction. The refund request may include one or more parameters contained therein. Such parameters may include, but are not limited to, a merchant name, a merchant category code, a date of the transaction, an amount of the transaction, an account number associated with the transaction, and the like.

At step 404, organization computing system 104 may determine that the transaction involved reserved funds 130. For example, transaction agent 118 based on, for example, the one or more parameters included in the refund request may determine that the transaction involved reserved funds 130. In some embodiments, transaction agent 118 may parse a listing of transactions 126 associated with user's profile 122 to determine if the refund request involved reserved funds 130.

At step 406, in response to organization computing system 104 determining that the transaction involved funds 130, organization computing system 104 may credit the user's account with reserved funds. For example, transaction agent 118 may credit the user's reserved funds 130 with the amount specified in the refund request and re-opposed one or more rules on those funds. For example, the funds reimbursed to the user may have the original one or more rules imposed thereon.

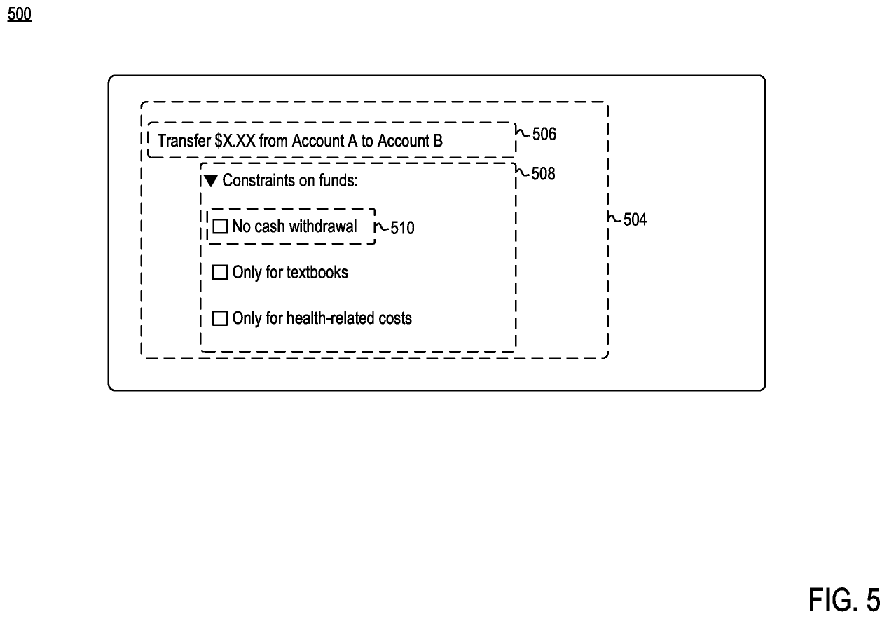

FIG. 5 is a block diagram illustrating an exemplary graphical user interface (GUI) 500, according to example embodiments. GUI 500 may be representative of an interface displayed to a transferor via application 112. Through GUI 500, a transferor may define one or more constraints on a transfer from an account associated with the transferor to an account associated with a transferee.

GUI 500 may include graphical element 504. Graphical element 504 may include one or more selectable items for defining a transfer from transferor account to transferee account. Graphical element 504 may include graphical element 506 and 508. Graphical element 506 may specify the funds to be transferred from transferor's account to transferee's account. For example, as illustrated, graphical element 506 may include: “Transfer $X.XX from Account A to Account B.”

Graphical element 506 may include one or more constraints that may be placed on the transfer from Account A to Account B. For example, graphical element 506 may include a drop down option that allows users to select from one or more constraints 510. As shown, exemplary constraints may include “No cash withdrawal,” “Only for textbooks,” and “Only for health-related costs.”

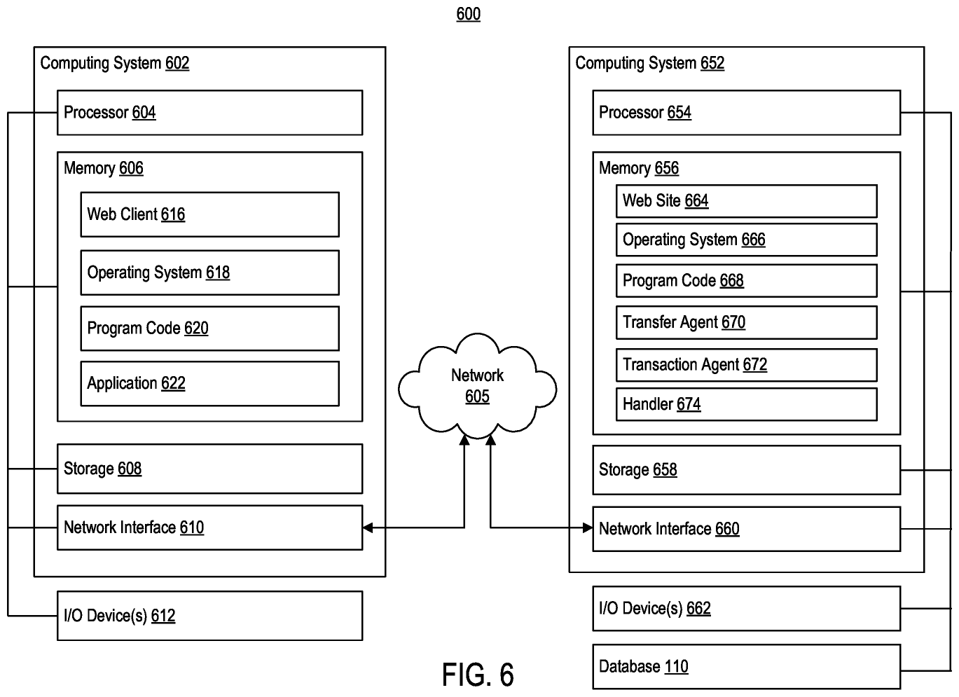

FIG. 6 is a block diagram illustrating an exemplary computing environment 600, according to some embodiments. Computing environment 600 includes computing system 602 and computing system 652. Computing system 602 may be representative of transferor device 102 and/or transferee device 106. Computing system 652 may be representative of organization computing system 104.

Computing system 602 may include a processor 604, a memory 606, a storage 608, and a network interface 610. In some embodiments, computing system 602 may be coupled to one or more I/O device(s) 612 (e.g., keyboard, mouse, etc.).

Processor 604 may retrieve and execute program code 620 (i.e., programming instructions) stored in memory 606, as well as stores and retrieves application data. Processor 604 may be included to be representative of a single processor, multiple processors, a single processor having multiple processing cores, and the like. Network interface 610 may be any type of network communications allowing computing system 602 to communicate externally via computing network 605. For example, network interface 610 is configured to enable external communication with computing system 652.

Storage 608 may be, for example, a disk storage device. Although shown as a single unit, storage 608 may be a combination of fixed and/or removable storage devices, such as fixed disk drives, removable memory cards, optical storage, network attached storage (NAS), storage area network (SAN), and the like.

Memory 606 may include application 616, operating system 618, and program code 620. Program code 620 may be accessed by processor 604 for processing (i.e., executing program instructions). Program code 620 may include, for example, executable instructions for communicating with computing system 652 to display one or more pages of website 664. Application 616 may enable a user of computing system 602 to access a functionality of computing system 652. For example, application 616 may access content managed by computing system 652, such as website 664. The content that is displayed to a user of computing system 602 may be transmitted from computing system 652 to computing system 602, and subsequently processed by application 616 for display through a graphical user interface (GUI) of computing system 602.

Computing system 652 may include a processor 654, a memory 656, a storage 658, and a network interface 660. In some embodiments, computing system 652 may be coupled to one or more I/O device(s) 662. In some embodiments, computing system 652 may be in communication with database 110.

Processor 654 may retrieve and execute program code 668 (i.e., programming instructions) stored in memory 656, as well as stores and retrieves application data. Processor 654 is included to be representative of a single processor, multiple processors, a single processor having multiple processing cores, and the like. Network interface 660 may be any type of network communications enabling computing system 652 to communicate externally via computing network 605. For example, network interface 660 allows computing system 652 to communicate with computer system 602.

Storage 658 may be, for example, a disk storage device. Although shown as a single unit, storage 658 may be a combination of fixed and/or removable storage devices, such as fixed disk drives, removable memory cards, optical storage, network attached storage (NAS), storage area network (SAN), and the like.

Memory 656 may include website 664, operating system 666, program code 668, transfer agent 670, transaction agent 672, and handler 674. Program code 668 may be accessed by processor 654 for processing (i.e., executing program instructions). Program code 668 may include, for example, executable instructions configured to perform steps discussed above in conjunction with FIGS. 2-4. As an example, processor 654 may access program code 668 to perform operations related to transferring funds between a transferor and a transferee, where the transfer may include one or more constraints on use of the funds. In another example, processor 654 may access program code 668 to facilitate a transaction using reserved funds. Website 664 may be accessed by computing system 602. For example, website 664 may include content accessed by computing system 602 via a web browser or application.

Transfer agent 670 may be configured to manage one or more transfers between a transferor and a transferee. For example, transfer agent 670 may be configured to manage a transfer from an account associated with a transferor to an account associated with a transferee. Via transfer agent 670, a transferor may place one or more constraints on a transfer between transferor account and transferee account. Exemplary constraints that transferor may place on such transfer may include, but are not limited to, one or more merchant names, one or more merchant category codes, a number of transactions using the funds, cash withdrawal, and the like. Transfer agent 670 may store the funds transferred by transferor to transferee as reserved funds in the transferee's account.

Transaction agent 672 may be configured to manage one or more transactions of one or more users. For example, transaction agent 672 may be configured to manage one or more transactions for one or more users. Transaction agent 672 may communicate with one or more third-party merchants. For example, a third-party merchant may submit a transaction request to computing system 652. Transaction request may include, for example, a merchant name, a merchant category code, the price of an item to be transacted and an account number (e.g., checking account number, credit card account number, etc.) associated with a counterparty to the transaction. Upon receiving a transaction request, transaction agent 672 may query database 110 to determine if the counterparty to the transaction has sufficient funds to perfect the transaction request. In some embodiments, transaction agent 672 may be configured to determine whether the transaction request is associated with one or more constraints. For example, transaction agent 672 may determine that the user has reserved funds in his or her account. Accordingly, transaction agent 672 may determine whether the transaction request satisfies any of the rules associated with reserved funds.

Handler 674 may be configured to manage an account associated with each user. For example, account handler 674 may be configured to communicate with database 110.

While the foregoing is directed to embodiments described herein, other and further embodiments may be devised without departing from the basic scope thereof. For example, aspects of the present disclosure may be implemented in hardware or software or a combination of hardware and software. One embodiment described herein may be implemented as a program product for use with a computer system. The program(s) of the program product define functions of the embodiments (including the methods described herein) and can be contained on a variety of computer-readable storage media. Illustrative computer-readable storage media include, but are not limited to: (i) non-writable storage media (e.g., read-only memory (ROM) devices within a computer, such as CD-ROM disks readably by a CD-ROM drive, flash memory, ROM chips, or any type of solid-state non-volatile memory) on which information is permanently stored; and (ii) writable storage media (e.g., floppy disks within a diskette drive or hard-disk drive or any type of solid state random-access memory) on which alterable information is stored. Such computer-readable storage media, when carrying computer-readable instructions that direct the functions of the disclosed embodiments, are embodiments of the present disclosure.

It will be appreciated to those skilled in the art that the preceding examples are exemplary and not limiting. It is intended that all permutations, enhancements, equivalents, and improvements thereto are apparent to those skilled in the art upon a reading of the specification and a study of the drawings are included within the true spirit and scope of the present disclosure. It is therefore intended that the following appended claims include all such modifications, permutations, and equivalents as fall within the true spirit and scope of these teachings.

What is claimed:

1. A method of securely transferring funds between a transferor and a transferee, comprising:
receiving, by a computing system, a request to transfer funds from a first account associated with the transferor to a second account associated with the transferee;
identifying, by the computing system, one or more constraints specified in the request that are associated with the funds, wherein the one or more constraints define one or more rules related to use of the funds by the transferee;
storing, by the computing system, the funds as reserved funds in the second accounts associated with the transferee;
receiving, by the computing system from a third-party vendor, a transaction request for verifying a transaction between the transferee and the third-party vendor;
identifying, by the computing system, one or more parameters associated with the transaction request;
determining, by the computing system, that the one or more parameters associated with the transaction request is in accordance with the one or more rules related to use of the funds; and
based on the determining, granting, by the computing system, the transaction request.

2. The method of claim 1, further comprising:
receiving, by the computing system from a second third-party vendor, a second transaction request for verifying a second transaction between the transferee and the second third-party vendor;
identifying, by the computing system, one or more second parameters associated with the second transaction request;
determining, by the computing system, that the one or more second parameters associated with the transaction request violate the one or more rules related to use of the funds;
identifying, by the computing system, that the transferee has enough funds in the second account, absent the reserved funds, to satisfy the second transaction request; and
based on the identifying, granting, by the computing system, the second transaction request.

3. The method of claim 1, further comprising:
receiving, by the computing system from a second third-party vendor, a second transaction request for verifying a second transaction between the transferee and the second third-party vendor;
identifying, by the computing system, one or more second parameters associated with the second transaction request;
determining, by the computing system, that the one or more second parameters associated with the transaction request violate the one or more rules related to use of the funds;
identifying, by the computing system, that the transferee has insufficient funds in the second account, absent the reserved funds, to satisfy the second transaction request; and
based on the identifying, rejecting, by the computing system, the second transaction request.

4. The method of claim 1, wherein identifying, by the computing system, the one or more parameters associated with the transaction request comprises:
identifying a merchant category code associated with the third-party merchant.

5. The method of claim 1, wherein receiving, by the computing system from the third-party vendor, the transaction request for verifying the transaction between the transferee and the third-party vendor comprises:
receiving a cash withdrawal request from the third-party vendor.

6. The method of claim 1, further comprising:
receiving, by the computing system from a second third-party vendor, a second transaction request for verifying a second transaction between the transferee and the second third-party vendor;
identifying, by the computing system, one or more second parameters associated with the second transaction request;
determining, by the computing system, that the one or more second parameters associated with the transaction request violate the one or more rules related to use of the funds;
identifying, by the computing system, that the transferee has insufficient funds in the second account, absent the reserved funds, to satisfy the second transaction request; and
determining, by the computing system, that the one or more rules comprise an exception for overdraft; and
based on the identifying, granting, by the computing system, the second transaction request by first withdrawing a first amount from non-reserved funds and then withdrawing a remaining amount from the reserved funds.

7. The method of claim 1, further comprising:
receiving, by the computing system from the third-party merchant, a refund in response to a user returning one or more items exchanged in the transaction request;
identifying, by the computing system, that the transaction request comprised the reserved funds; and
allocating, by the computing system, funds associated with the refund to the reserved funds.

8. A system, comprising:
a processor; and
a memory having programming instructions stored thereon, which, when executed by the processor, perform one or more operations comprising:
receiving a request to transfer funds from a first account associated with a transferor to a second account associated with a transferee;
identifying one or more constraints specified in the request that are associated with the funds, wherein the one or more constraints define one or more rules related to use of the funds by the transferee;
receiving, from a third-party vendor, a transaction request for verifying a transaction between the transferee and the third-party vendor;
identifying one or more parameters associated with the transaction request;
determining that the one or more parameters associated with the transaction request is in accordance with the one or more rules related to use of the funds; and
based on the determining, granting the transaction request.

9. The system of claim 8, wherein the one or more operations further comprise:
receiving, from a second third-party vendor, a second transaction request for verifying a second transaction between the transferee and the second third-party vendor;
identifying one or more second parameters associated with the second transaction request;
determining that the one or more second parameters associated with the transaction request violate the one or more rules related to use of the funds;
identifying that the transferee has enough unreserved funds in the second account to satisfy the second transaction request; and
based on the identifying, granting the second transaction request.

10. The system of claim 8, wherein the one or more operations further comprise:
receiving, from a second third-party vendor, a second transaction request for verifying a second transaction between the transferee and the second third-party vendor;
identifying one or more second parameters associated with the second transaction request;
determining that the one or more second parameters associated with the transaction request violate the one or more rules related to use of the funds;
identifying that the transferee has insufficient unreserved funds in the second account, absent the reserved funds, to satisfy the second transaction request; and
based on the identifying, rejecting the second transaction request.

11. The system of claim 8, wherein identifying the one or more parameters associated with the transaction request comprises:
identifying a merchant category code associated with the third-party merchant.

12. The system of claim 8, wherein receiving, from the third-party vendor, the transaction request for verifying the transaction between the transferee and the third-party vendor comprises:
receiving a cash withdrawal request from the third-party vendor.

13. The system of claim 8, wherein the one or more operations further comprise:
receiving, from a second third-party vendor, a second transaction request for verifying a second transaction between the transferee and the second third-party vendor;
identifying one or more second parameters associated with the second transaction request;
determining, by the computing system, that the one or more second parameters associated with the transaction request violate the one or more rules related to use of the funds;
identifying that the transferee has insufficient unreserved funds in the second account to satisfy the second transaction request; and
determining that the one or more rules comprise an exception for overdraft; and
based on the identifying, granting the second transaction request by first withdrawing a first amount from unreserved funds and then withdrawing a remaining amount from reserved funds.

14. The system of claim 8, wherein the one or more operations further comprise:
receiving, by the computing system from the third-party merchant, a refund in response to a user returning one or more items exchanged in the transaction request;
identifying, by the computing system, that the transaction request comprised the reserved funds; and
allocating, by the computing system, funds associated with the refund to reserved funds.

15. A non-transitory computer readable medium including one or more sequences of instructions that, when executed by one or more processors, cause:
receiving, by a computing system via a graphical user interface (GUI), a request to transfer funds from a first account associated with a transferor to a second account associated with a transferee, wherein the request comprises one or more constraints defined by the transferor via the GUI;
identifying, by the computing system, the one or more constraints specified in the request that are associated with the funds, wherein the one or more constraints define one or more rules related to use of the funds by the transferee;
storing, by the computing system, the funds as reserved funds in the second accounts associated with the transferee;
receiving, by the computing system from a third-party vendor, a transaction request for verifying a transaction between the transferee and the third-party vendor;
identifying, by the computing system, one or more parameters associated with the transaction request;
determining, by the computing system, that the one or more parameters associated with the transaction request is in accordance with the one or more rules related to use of the funds; and
based on the determining, granting, by the computing system, the transaction request.

16. The non-transitory computer readable medium of claim 15, further comprising:
receiving, by the computing system from a second third-party vendor, a second transaction request for verifying a second transaction between the transferee and the second third-party vendor;
identifying, by the computing system, one or more second parameters associated with the second transaction request;
determining, by the computing system, that the one or more second parameters associated with the transaction request violate the one or more rules related to use of the funds;
identifying, by the computing system, that the transferee has enough funds in the second account, absent the reserved funds, to satisfy the second transaction request; and
based on the identifying, granting, by the computing system, the second transaction request.

17. The non-transitory computer readable medium of claim 15, further comprising:
receiving, by the computing system from a second third-party vendor, a second transaction request for verifying a second transaction between the transferee and the second third-party vendor;
identifying, by the computing system, one or more second parameters associated with the second transaction request;
determining, by the computing system, that the one or more second parameters associated with the transaction request violate the one or more rules related to use of the funds;
identifying, by the computing system, that the transferee has insufficient funds in the second account, absent the reserved funds, to satisfy the second transaction request; and
based on the identifying, rejecting, by the computing system, the second transaction request.

18. The non-transitory computer readable medium of claim 15, wherein identifying, by the computing system, the one or more parameters associated with the transaction request comprises:
identifying a merchant category code associated with the third-party merchant.

19. The non-transitory computer readable medium of claim 15, wherein receiving, by the computing system from the third-party vendor, the transaction request for verifying the transaction between the transferee and the third-party vendor comprises:
receiving a cash withdrawal request from the third-party vendor.

20. The non-transitory computer readable medium of claim 15, further comprising:
receiving, by the computing system from a second third-party vendor, a second transaction request for verifying a second transaction between the transferee and the second third-party vendor;
identifying, by the computing system, one or more second parameters associated with the second transaction request;
determining, by the computing system, that the one or more second parameters associated with the transaction request violate the one or more rules related to use of the funds;
identifying, by the computing system, that the transferee has insufficient funds in the second account, absent the reserved funds, to satisfy the second transaction request; and
determining, by the computing system, that the one or more rules comprise an exception for overdraft; and
based on the identifying, granting, by the computing system, the second transaction request by first withdrawing a first amount from non-reserved funds and then withdrawing a remaining amount from the reserved funds.
